(19) United States
(12) Patent Application Publication
(10) Pub. No.: US 2023/0017486 A1
(43) Pub. Date: Jan. 19, 2023

(54) DISPLAY DEVICE, DISPLAY METHOD, AND VEHICLE

(71) Applicant: Panasonic Intellectual Property Management Co., Ltd., Osaka (JP)

(72) Inventors: Hajime HOMMA, Kanagawa (JP); Makoto HINATA, Kanagawa (JP); Masahiro ANEZAKI, Kanagawa (JP); Hirotada YAGINUMA, Tokyo (JP); Ayano KAWAE, Tokyo (JP); Chie HIROSAWA, Tokyo (JP); Xiangmei PIAO, Tokyo (JP)

(73) Assignee: Panasonic Intellectual Property Management Co., Ltd., Osaka (JP)

(21) Appl. No.: 17/947,879

(22) Filed: Sep. 19, 2022

Related U.S. Application Data
(63) Continuation of application No. PCT/JP2020/046362, filed on Dec. 11, 2020.

(30) Foreign Application Priority Data
Mar. 23, 2020 (JP) 2020-050757

(51) Int. Cl. B60K 35/00

(52) U.S. Cl. CPC B60K 35/00; B60K 2370/1868; B60K 2370/1876; B60K 2370/349; B60K 2370/785

(57) ABSTRACT

A display device, a display method, and a vehicle are disclosed. The device includes: a transmissive display that is provided to a moving body; and a display controller that changes transparency of the transmissive display based on traveling information on traveling of the moving body.

### TECHNICAL FIELD

The present disclosure relates to a display device, a display method, and a vehicle.

### BACKGROUND ART

Patent Literature 1 discloses a technique for displaying information on a window of a moving body in accordance with an attribute or preference of an occupant of the moving body.

### CITATION LIST

### Patent Literature

### PTL 1

Japanese Patent Application Laid-Open No. 2018-169244

### SUMMARY

### Technical Problem

One non-limiting and exemplary embodiment facilitates providing a display device, a display method, and a vehicle each capable of highly integrating information display and an entertainment element.

### Solution to Problem

A display device according to an embodiment of the present disclosure includes: a transmissive display that is provided to a moving body; and a display controller that changes transparency of the transmissive display based on traveling information on traveling of the moving body.

A vehicle according to an embodiment of the present disclosure includes the display device described above.

A display method according to an embodiment of the present disclosure includes: inputting traveling information on traveling of a moving body; changing transparency of a transmissive display provided to the moving body based on the inputted traveling information; and displaying, based on the inputted traveling information, display information so as to be superimposed on the transmissive display, the transparency of which is changed.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary configuration of a display system according to an embodiment of the present disclosure;

FIG. 2 illustrates an exemplary hardware configuration of an electronic control unit (ECU) of an on-board device;

FIG. 3 illustrates an exemplary functional configuration of the ECU of the on-board device;

FIG. 4 is a diagram for describing an exemplary method of determining a display position by a display position determiner;

FIG. 5 is another diagram for describing an exemplary method of determining a display position by the display position determiner;

FIG. 6 is still another diagram for describing an exemplary method of determining a display position by the display position determiner;

FIG. 7 illustrates an exemplary hardware configuration and an exemplary functional configuration of an information processing apparatus of a center server;

FIG. 8 is a cross-sectional view of a display device;

FIG. 9 illustrates a situation where transparency is changed in accordance with vehicle speed;

FIG. 10 illustrates a situation where a VR image etc. is displayed in accordance with change in the transparency;

FIG. 11 illustrates a situation where AR try-on, AR make-up, etc. is performed in accordance with change in the transparency;

FIG. 12 illustrates a situation where the transparency of a display device is increased and an AR image etc. is superimposed on scenery through a window;

FIG. 13 illustrates a situation where information of a hot spot or the like is displayed;

FIG. 14 illustrates a situation where different images are respectively displayed inside and outside a vehicle; and

FIG. 15 is a flowchart for describing a display method of the display device.

### DESCRIPTION OF EMBODIMENTS

There has been a technique disclosed for displaying information on a window of a moving body in accordance with an attribute or preference of an occupant of the moving body. The conventional technique, however, faces a challenge of providing entertainment on the window of the moving body since it only superimposes an image on the scenery seen through the window of the moving body, for example. To address the challenge, a display device according to the present disclosure is capable of highly integrating information display and an entertainment element.

Hereinafter, a preferred embodiment of the present disclosure will be described in detail with reference to the accompanying drawings. Note that components having substantially the same functions are denoted by the same reference signs in the present specification and drawings, and the repetitive descriptions thereof are omitted.

### EMBODIMENT

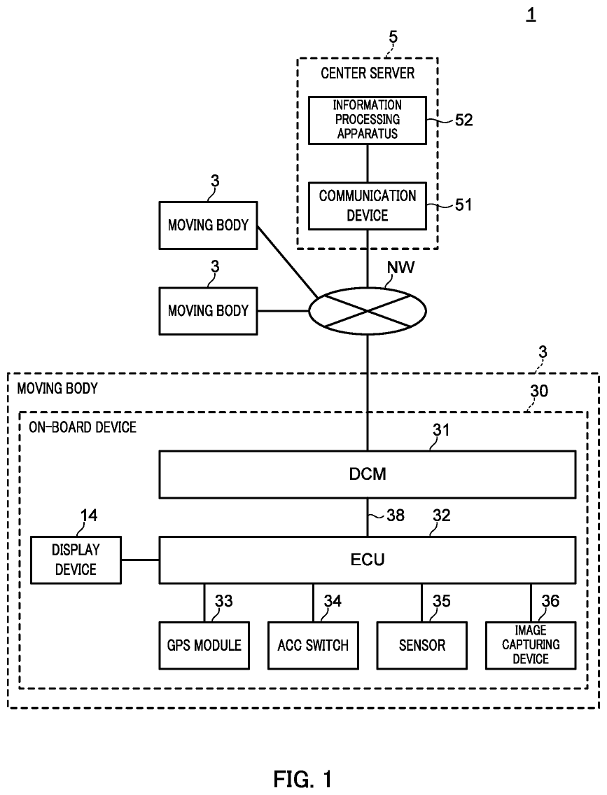

FIG. 1 illustrates an exemplary configuration of a display system according to an embodiment of the present disclosure. Display system 1 includes on-board device 30 that is mounted on each of a plurality of moving bodies 3 and center server 5 that can communicate with on-board device 30. Moving body 3 is, for example, a vehicle such as a passenger car, freight car, bus, shared taxi, motorcycle, and railroad car. Note that moving body 3 is not limited to a vehicle and may be an aircraft, amusement facility, etc. In the following description, moving body 3 is a vehicle.

On-board device 30 includes data communication module (DCM) 31, electronic control unit (ECU) 32, global positioning system (GPS) module 33, accessory (ACC) switch 34, sensor 35, image capturing device 36, and display device 14, for example. Note that on-board device 30 includes, in addition to those devices, a car navigation system, audio equipment, an inverter, a motor, and auxiliary equipment, for example.

DCM 31 is a communication device that performs bidirectional communication with center server 5 via communication network NW. Communication network NW is, for example, a cellular phone network terminating at a large number of base stations, or a satellite communication network using communication satellites. In addition, DCM 31 is connected to ECU 32 via controller area network (CAN) 38, which is an in-vehicle network, to enable mutual communication, transmits various types of information to an external device of a vehicle in response to a request from ECU 32, and relays information transmitted from the external device of the vehicle to ECU 32. The external device is, for example, center server 5 and a vehicle-to-everything (V2X) communication device. The V2X is a communication technique to connect a vehicle to various objects. The V2X includes communication such as vehicle to vehicle (V2V), vehicle to pedestrian (V2P), vehicle to infrastructure (V2I), and vehicle to network (V2N).

ECU 32 is an electronic control unit that performs various types of control processing related to predetermined functions of the vehicle, and is, for example, a motor ECU, hybrid ECU, engine ECU, and the like. ECU 32 collects vehicle information and inputs the information to DCM 31, for example.

The vehicle information includes, for example, vehicle position information, speed information, vehicle status information, and captured image information. The vehicle position information is information indicating the current position of the vehicle, and is, for example, information indicating the latitude and longitude at which the vehicle is traveling. The vehicle position information is transmitted from, for example, the car navigation system and GPS module 33. The speed information is information indicating the current speed of the vehicle transmitted from a vehicle speed sensor. The vehicle status information is, for example, a signal indicating whether ACC switch 34 is ON or OFF. In addition to this, the vehicle status information includes a windshield wiper operation status, defogger status, accelerator opening, brake depression, steering volume of the steering wheel, and information obtained from advanced driver-assistance systems (ADAS). The ADAS is a system that supports a driver's driving operation in order to enhance the convenience of road traffic. The captured image information is information indicating contents of an image captured by image capturing device 36. The captured image information includes time information indicating the time of image generation.

Image capturing device 36 is a camera including an image sensor such as a charge coupled device (CCD) and complementary metal oxide semiconductor (CMOS). Image capturing device 36 includes, for example, an inside image capturing device that captures an image of the inside of the vehicle and an outside image capturing device that captures an image of the outside of the vehicle.

The inside image capturing device is placed at a position where faces of occupants of a driver's seat, a passenger's seat, a rear seat of the vehicle, for example, can be captured. Such a position includes, for example, a dashboard of the vehicle, an instrument panel of the driver's seat, and the ceiling of the vehicle. The vehicle is not necessarily provided with a single inside image capturing device, and may be provided with a plurality of inside image capturing devices. The inside image capturing device outputs captured image information indicating a captured inside image of the vehicle.

The outside image capturing device may be an omni-directional camera that captures an image of the scenery around the vehicle, and a panoramic camera, for example. The scenery around the vehicle is, for example, the scenery in front of the vehicle, the scenery on the side of the vehicle (driver's seat door side of the vehicle or passenger's seat door side of the vehicle), and the scenery behind the vehicle. The scenery includes, for example, a road on which the vehicle is traveling, an object present on the road, a sidewalk facing the road, and an object present on the sidewalk. The object present on the road is, for example, a vehicle, motorcycle, bus, taxi, building, structure (advertisement, road sign, traffic light, telegraph pole, etc.), person, animal, and fallen object. The object present on the sidewalk is, for example, a pedestrian, animal, bicycle, structure, and fallen object. The outside image capturing device is placed at a position where the scenery outside the vehicle can be captured, for example. Such a position includes a front grille, side mirror, ceiling, and rear bumper, for example. The outside image capturing device outputs captured image information indicating a captured outside image of the vehicle.

GPS module 33 receives a GPS signal transmitted from satellite, measures the position of the vehicle on which GPS module 33 is mounted. GPS module 33 is communicably connected to ECU 32 via CAN 38, and the vehicle position information is transmitted to ECU 32.

ACC switch 34 is a switch that turns on and off accessory power supply of the vehicle in response to an operation of an occupant. For example, ACC switch 34 turns on and off the accessory power supply in response to an operation to a power switch provided on an instrument panel near a steering wheel of the driver's seat in the vehicle compartment. The power switch is, for example, a button switch for operating an ignition (not illustrated). An output signal of ACC switch 34 is exemplary information indicating the start and stop of the vehicle. To be more specific, when the output signal of ACC switch 34 turns an ON signal from an OFF signal, it indicates the start of the vehicle, and when the output signal of ACC switch 34 turns the OFF signal from the ON signal, it indicates the stop of the vehicle. ACC switch 34 is communicatively connected to ECU 32, for example, through CAN 38, and the status signal (ON signal/OFF signal) is transmitted to ECU 32.

Sensor 35 is, for example, a sensor detecting a voltage applied to the inverter, a sensor detecting a voltage applied to the motor, a sensor detecting a vehicle speed, a sensor detecting accelerator opening, a sensor detecting a steering volume of the steering wheel, and a sensor detecting a brake operation amount. In addition, sensor 35 may include, for example, an acceleration sensor detecting acceleration of the vehicle, and an angular velocity sensor (gyroscope) detecting angular velocity of the vehicle. Detection information outputted from sensor 35 is taken into ECU 32 through CAN 38.

Display device 14 is, for example, a transparent liquid crystal display or transparent organic electroluminescence (EL) display with light transmission and dimming properties. Display device 14 is provided to a vehicle window, for example. The vehicle window includes a windshield, side windows, and a rear window, for example. Note that display device 14 may be provided to, besides the vehicle window, a window installed in a boarding door of a railroad car, window installed near a seat of a railroad car, cockpit window of an aircraft, cabin window of an aircraft, and the like. An exemplary configuration of display device 14 will be described later.

Center server 5 is a server that provides various services by collecting information from a plurality of vehicles and distributing information to occupants of the plurality of vehicles. The various services include, for example, a car sharing service, authentication key service, trunk delivery service, B2C car sharing service, and advertisement distribution service.

Center server 5 includes communication device 51 and information processing apparatus 52. Communication device 51 is a communication device that performs bidirectional communication with each of the plurality of vehicles via communication network NW under the control of information processing apparatus 52. Information processing apparatus 52 performs various types of control processing in center server 5. Information processing apparatus 52 is composed of a server computer including, for example, a central processing unit (CPU), random access memory (RAM), read only memory (ROM), auxiliary storage device, and input/output interface.

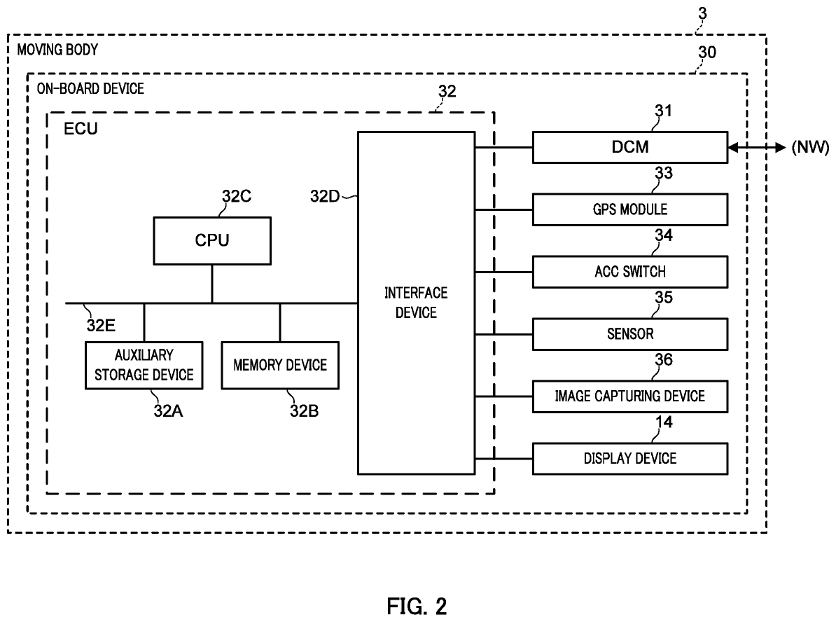

Next, an exemplary hardware configuration of ECU 32 of on-board device 30 will be described with reference to FIG. 2. FIG. 2 illustrates the exemplary hardware configuration of the ECU of the on-board device. ECU 32 includes auxiliary storage device 32A, memory device 32B, CPU 32C, and interface device 32D. These are connected to each other through bus line 32E.

Auxiliary storage device 32A is a hard disk drive (HDD) or flash memory that stores, for example, a file and data necessary for processing in ECU 32.

When a program starting indication is present, memory device 32B reads a program from auxiliary storage device 32A and stores the program. CPU 32C executes the program stored in memory device 32B and implements various functions of ECU 32 according to the program.

Interface device 32D is, for example, an interface that connects CPU 32C to DCM 31 via CAN 38, and connects image capturing device 36, sensor 35, etc. to DCM 31 via CAN 38.

Next, functions of ECU 32 of on-board device 30 will be described with reference to FIG. 3. FIG. 3 illustrates an exemplary functional configuration of the ECU of the on-board device.

Memory device 32B includes information display program 331 that implements a function of CPU 32C and display information DB 332 that stores display information to be displayed on display device 14. The display information is, for example, image information and text information to be displayed on a screen of display device 14. The image information is, for example, an augment reality (AR) image, virtual reality (VR) image, mixed reality (MR) image, and substitutional reality (SR) image. The AR is a technique for providing new perception by superimposing information on an object or the like in real space. The VR is a technique for building reality (realism) on virtual space. The MR is a technique for building reality on a mixture of real and virtual space. The SR is a technique for seamlessly replacing information stored in the past with information available in the present. The text information is, for example, text information related to explanation and information of a building, landmark, etc.

Display information DB 332 includes, for example, a plurality of corresponding positions and display information associated with each of the plurality of corresponding positions. The corresponding position is, for example, position information representing by the latitude and longitude. In display information DB 332, each of the plurality of corresponding positions is associated with, for example, past image information, text information, future image information, etc. The past image information is, for example, image information reproducing a building, scenery, etc. that was present in the past. The future image information is image information representing a building to be constructed in the future.

CPU 32C of ECU 32 includes vehicle information transceiver 321, captured image information manager 323, display position determiner 22, and display controller 26.

Vehicle information transceiver 321 has a function of receiving vehicle information and a function of transmitting the vehicle information to center server 5.

Display position determiner 22 determines the display position of display information on display device 14. An exemplary method of determining the display position of the display information will be described below.

First, display position determiner 22 extracts, for example, a face of an occupant from an inside image of the vehicle transmitted by the inside image capturing device, and specifies the position of the occupant who watches a screen of display device 14 based on the position and direction of the occupant's face in the vehicle and the vehicle position.

Next, display position determiner 22 specifies, for example, the position where the screen of display device 14 is provided in the vehicle as the screen position. For example, the position of the screen of display device 14 is determined when display device 14 is installed in the vehicle, and thus, information indicating the position of the screen of display device 14 is linked to vehicle identification information corresponding to the vehicle, and the linked information is stored in memory device 32B, for example. The vehicle identification information is, for example, a vehicle index number or vehicle identifier (ID). When on-board device 30 is activated, display position determiner 22 refers to memory device 32B and reads the screen position of display device 14 using the vehicle identification information. This process makes it possible to specify that the screen of display device 14 is provided to, for example, a windshield, side window, or the like.

Note that the position where the screen of display device 14 is provided can be configured more in detail. For example, when display device 14 is provided in a partial area of a windshield, the entire area of the windshield viewed flat from the inside of the vehicle toward the front may be divided into four areas of the first quadrant to the fourth quadrant of the rectangular coordinates, for example, identification information of each area may be linked to the vehicle identification information, and the linked information may be stored in memory device 32B or the like. This allows display position determiner 22 to specify that display device 14 is placed, for example, in an area near the upper left of the windshield, an area near the lower right of the windshield, or the like.

Next, display position determiner 22 specifies the display position of the display information in the scenery through the display screen. To be more specific, display position determiner 22 extracts, for example, a building from outside images of the vehicle in two frames that are continuously captured, and calculates the distance from the outside image capturing device to the building by the principle of stereo camera, based on the difference in the position of the building in the outside images between the two frames. Display position determiner 22 then specifies the position of the building based on the distance from the outside image capturing device to the building and the vehicle position. Subsequently, display position determiner 22 refers to display information DB 332 to determine whether the display information associated with the position of the building is present in display information DB 332, and when it is present, display position determiner 22 specifies the position of the building as the display position of the display information.

Note that display position determiner 22 may be configured to specify the display position of the display information by another method. For example, display position determiner 22 calculates a range of latitude and longitude corresponding to the area of the scenery included in the outside image of the vehicle, based on the vehicle position and a capturing range of the outside image capturing device. Display position determiner 22 then specifies the display position of the display information by searching display information DB 332 for the display position of the display information within the calculated range of latitude and longitude.

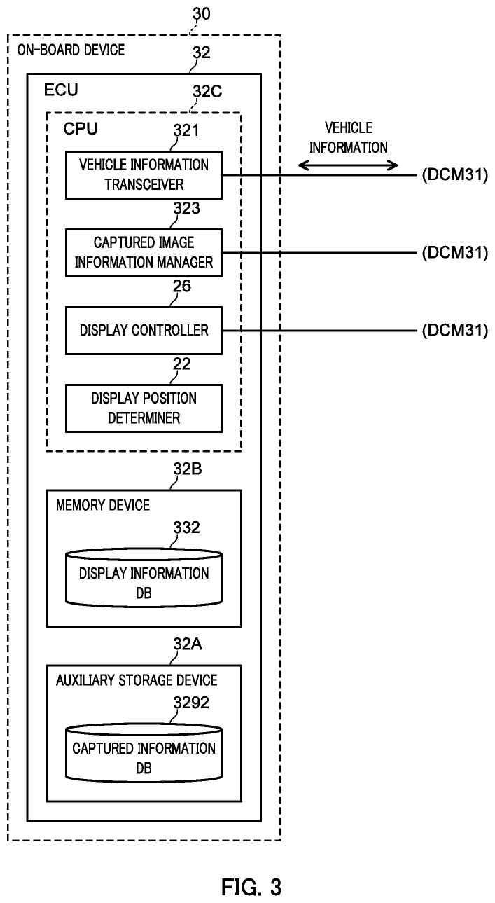

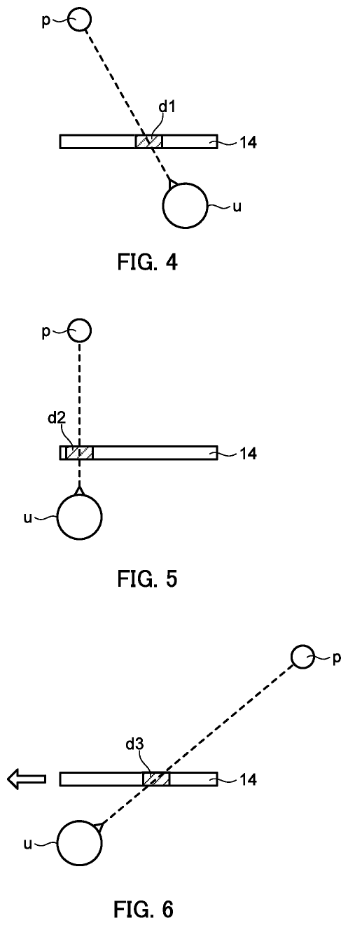

Finally, display position determiner 22 determines the display position of the display information based on the specified current position of the occupant, the specified screen position, the specified display position of the display information, etc. A specific examples of a method of determining the display position of the display information will be described with reference to FIG. 4.

FIGS. 4 to 6 are diagrams for each describing an exemplary method of determining the display position by the display position determiner. Each of FIGS. 4 to 6 illustrates display device 14 provided to the vehicle window, occupant u watching display device 14 in the vehicle compartment, and position p. Position p is a position outside the vehicle with which the display information is associated in the scenery viewed by occupant u through display device 14.

FIG. 4 illustrates, for example, a case where occupant u in the vehicle is present in a position near the back of the right rear window of the vehicle, and from the position, sees right front position p outside the vehicle via display device 14. In this case, display position determiner 22 determines the display position of display information on display device 14 based on the position of occupant u, the position of display device 14, and position p.

In the following, the position of occupant u is referred to as an “occupant position”, the position of display device 14 is referred to as a “screen position”, and position p with which display information is associated is referred to as “information-associated position p”.

In FIG. 4, display position determiner 22 determines the intersection point where the broken line connecting information-associated position p in the scenery and the occupant position intersects display device 14 as the center point of the display position of display information d1 associated with information-associated position p in the scenery.

Then, display position determiner 22 generates a display command indicating that display information d1 is displayed in the determined display position on display device 14, and inputs the display command to display controller 26. At this time, display position determiner 22 displays display information d1 in a display pattern according to the positional relationship between information-associated position p in the scenery and the occupant position. Note that display position determiner 22 may be configured to use a decorative display, flashing operation, sound effect, etc. for drawing attention to display information d1 on display device 14 in order to lead the line of sight by the sound and display before displaying display information d1 in a display pattern according to the positional relationship between information-associated position p in the scenery and the occupant position.

Next, as illustrated in FIG. 5, when occupant u moves to a position near the front of the right rear window of the vehicle, display position determiner 22 determines the intersection point where the broken line connecting information-associated position p in the scenery and the occupant position intersects display device 14 as the center point of the display position of display information d2 associated with information-associated position p in the scenery.

Display position determiner 22 then generates a display command indicating that display information d2 is displayed in the determined display position, and inputs the display command to display controller 26. The display pattern of display information d2 displayed by this process is different from the display pattern of display information d1 in FIG. 4.

After that, as the vehicle travels forward, information-associated position p in the scenery moves to the right rear side of the vehicle relatively. In this case, display position determiner 22 determines the intersection point where the broken line connecting information-associated position p in the scenery and the occupant position intersects display device 14 as the center point of the display position of display information d3 associated with information-associated position p in the scenery.

Then, display position determiner 22 generates a display command indicating that display information d3 is displayed in the determined display position on display device 14, and inputs the display command to display controller 26. The display pattern of display information d3 displayed by this process is different from the display pattern of display information d2 in FIG. 5.

As described above, display position determiner 22 determines a position overlapping information-associated position p in the scenery as seen from occupant u as a display position of display information d1, d2, and d3 on display device 14, based on the occupant position, the screen position, and information-associated position p. Then, display position determiner 22 generates a display command indicating that display information d1, d2, and d3 in a display pattern according to the positional relationship between information-associated position p in the scenery and the occupant position is displayed in the determined display position on display device 14, and inputs the display command to display controller 26.

This makes it possible to display display information d1, d2, and d3 in a display pattern as if it is present in real information-associated position p seen through display device 14, thereby enhancing the occupant's sense of immersion in display information d1, d2, and d3.

Captured image information manager 323 generates a captured image information table (captured image information DB 3292) by inputting the captured image information transmitted from image capturing device 36 for a certain period while embedding the time and vehicle position information in the transmitted captured image information.

Display controller 26 acquires, for example, information-associated position p, the occupant position, display position, speed information, vehicle position information, vehicle status information, captured image information, etc., and performs display processing for display device 14.

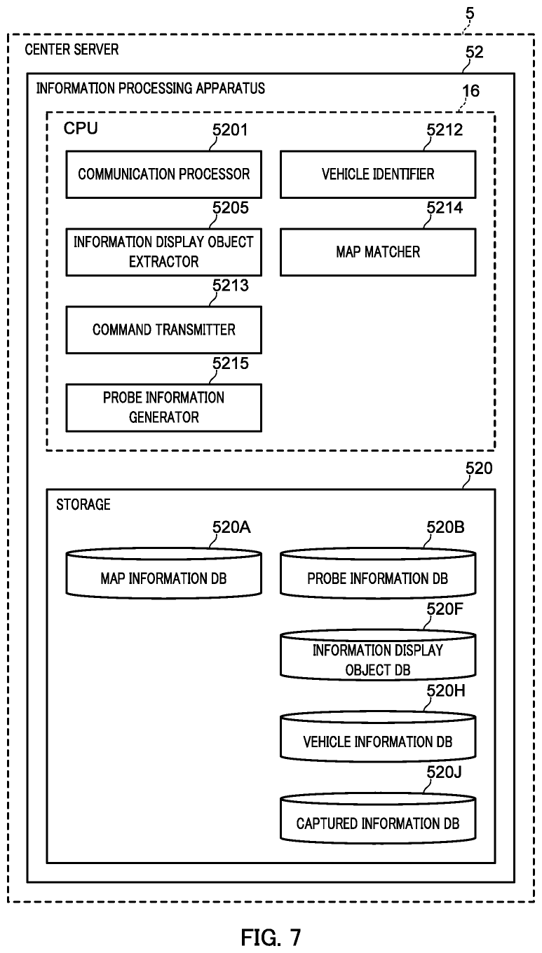

Next, an exemplary hardware configuration of information processing apparatus 52 of center server 5, for example, will be described with reference to FIG. 7. FIG. 7 illustrates the exemplary hardware configuration and an exemplary functional configuration of the information processing apparatus of the center server. Information processing apparatus 52 includes CPU 16 and storage 520.

CPU 16 includes communication processor 5201 that transmits and receives various kinds of information to and from each of a plurality of vehicles, information display object extractor 5205, vehicle identifier 5212, command transmitter 5213, map matcher 5214, and probe information generator 5215. Storage 520 includes map information DB 520A, probe information DB 520B, information display object DB 520F, vehicle information DB 520H, and captured image information DB 520J.

Information display object extractor 5205 extracts, based on the known image recognition processing, an information display object from the captured image information of image capturing device 36 included in probe information of each of the plurality of vehicles stored in probe information DB 520B. Information display object extractor 5205 then adds specific identification information to the extracted information display object, links meta-information, such as an image of the information display object and position information of the information display object, to the identification information, and stores the information display object in information display object DB 520F. Accordingly, information on the information display object extracted by information display object extractor 5205 is registered in information display object DB 520F in addition to information on the pre-registered information display object such as a signboard or digital signage on which advertisement information of a predetermined advertiser is displayed. This enhances the information display object, thereby improving convenience for an occupant. Note that the position information of the information display object added as the meta-information may be the vehicle position information itself included in the probe information that also includes the captured image information, which is a source of the extraction, or may be vehicle position information considering the position information of the information display object relative to the vehicle calculated from the captured image information. When the extracted information display object is the same as the information display object already registered in information display object DB 520F, information display object extractor 5205 does not store information on the extracted information display object in information display object DB 520F. This processing by information display object extractor 5205 may be performed in real time in response to the probe information sequentially received from each of the plurality of vehicles by communication processor 5201, or may be performed periodically on a certain amount of accumulated, unprocessed probe information.

Vehicle identifier 5212 identifies a vehicle passing through a geographic position or area where the captured image information is to be collected, based on the vehicle position information. Note that the latest captured image of a field where the vehicle actually travels is necessary for creating a three-dimensional advanced dynamic map to be used for autonomous driving of the vehicle. The field for which this dynamic map is created can be an example of the geographical position or area where the captured image information is to be collected.

For example, when the vehicle position information transmitted from each of a plurality of vehicles is inputted, vehicle identifier 5212 matches the vehicle position to the position or area where the captured image information is collected, and determines the vehicle that has passed through the position or area. Then, vehicle identifier 5212 selects vehicle information including the position information of the vehicle that is determined to have passed through from the vehicle information transmitted from each of a plurality of on-board devices 30, and extracts the vehicle identification information included in the selected vehicle information. After extracting the vehicle identification information, vehicle identifier 5212 transfers the extracted vehicle identification information to command transmitter 5213.

After the vehicle identification information is inputted to command transmitter 5213 from vehicle identifier 5212, command transmitter 5213 transmits a captured image information request command to the vehicle to which the vehicle identification information is assigned from a group of vehicles communicably connected to center server 5 via communication network NW. The captured image information provided in response to the captured image information request command is associated with data collection target area information, and is stored in storage 520 as captured image information DB 520J.

Map matcher 5214 specifies a link of a road where the vehicle is currently located based on map information DB 520A and the vehicle position information. Map information DB 520A is composed of geographic information system (GIS) data and the like. The GIS data includes a node corresponding to an intersection, a road link connecting nodes, a line and polygon corresponding to buildings, roads, or other geographic features. For example, identification information, i.e., link ID, is defined in advance for each of a plurality of road links that are included in map information DB 520A and compose a road network. Map matcher 5214 identifies the link ID of the road link where the vehicle is currently located by referring to map information DB 520A.

Probe information generator 5215 generates probe information including the vehicle information transmitted from the vehicle, time information, and the road link specified by map matcher 5214, at predetermined intervals. Then, probe information generator 5215 stores the generated probe information in probe information DB 520B.

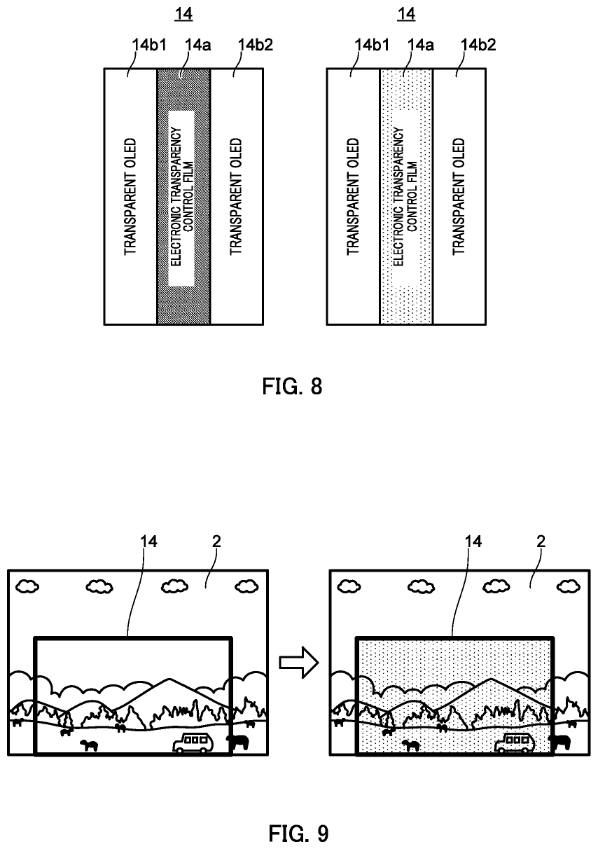

Next, an exemplary configuration of display device 14 and exemplary displays on display device 14 will be described with reference to FIG. 8 and the like.

FIG. 8 is a cross-sectional view of display device 14. Display device 14 is provided on a vehicle, for example, being attached to the inside or outside of a vehicle window. Note that display device 14 is not necessarily provided on a vehicle in this way. For example, display device 14 may be fixed to a frame of the vehicle so that the screen of display device 14 faces the inside or outside of the vehicle window. Display device 14 may also be embedded in the vehicle window. Further, display device 14 may be provided so as to cover the entire area of the vehicle window, or may be provided so as to cover a partial area of the vehicle window.

Display device 14 illustrated in FIG. 8 has a configuration in which two transparent OLEDs 14b1 and 14b2 have electronic transparency control film 14a in between, for example. Hereinafter, two transparent OLEDs 14b1 and 14b2 are collectively referred to as “transparent OLED” when they are not distinguished from each other. Electronic transparency control film 14a is an example of a transmissive display whose transparency is changeable. Transparent OLED 14b1 and transparent OLED 14b2 are examples of a display information display capable of displaying the display information.

Electronic transparency control film 14a is capable of controlling the shading of scenery seen through the vehicle window and controlling the shading of an image displayed on the transparent OLED by changing the transparency (visible light transmission), for example. Electronic transparency control film 14a may be capable of uniformly changing the transparency of entire electronic transparency control film 14a, or may be capable of changing the transparency of a partial area of electronic transparency control film 14a. Exemplary methods of changing the transparency of electronic transparency control film 14a are an electrochromic method, a gas chromic method that enables high-speed dimming control compared to the electrochromic method, and the like. When the transparency of a partial area of electronic transparency control film 14a is changed, a local dimming technique or a technique disclosed in Non Patent Literature 1 can be used (Non Patent Literature 1: https://www.jst.go.jp/pr/announce/20171017-3/index.html).

Transparent OLED 14b1 is an exemplary transparent display directed toward a first end face side of electronic transparency control film 14a. The first end face side of electronic transparency control film 14a is, for example, the inside of a window. Transparent OLED 14b2 is an exemplary transparent display directed toward a second end face side of electronic transparency control film 14a that is the opposite side of the first end face side. The second end side of electronic transparency control film 14a is the outside of a vehicle. Note that display device 14 may include a transparent liquid crystal display instead of the transparent OLED.

Display device 14 provided with two transparent OLEDs is capable of displaying different display information inside and outside the window.

For example, when an occupant enjoys playing a game in a vehicle during autonomous driving, the transparency of electronic transparency control film 14a may be reduced (e.g., visible light transmission of 30% or less) as illustrated on the left side of FIG. 8 to display the game screen on transparent OLED 14b1 and display an enlarged character on the screen on transparent OLED 14b2, for example.

When an occupant enjoys exercising, such as yoga or shadow boxing, in a vehicle during autonomous driving, the transparency of electronic transparency control film 14a may be reduced as illustrated on the left side of FIG. 8 to display an instruction video of the exercise on transparent OLED 14b1 and display a moving image of a person exercising in the vehicle on transparent OLED 14b2.

It is also possible to display a navigation screen, such as a map, on transparent OLED 14b1 and to display an image of a driver in the vehicle or an advertisement image distributed from an advertising company, for example, on transparent OLED 14b2 while the transparency of electronic transparency control film 14a is reduced.

In addition, the transparency of electronic transparency control film 14a may be increased (e.g., visible light transmission of 80% or more) as illustrated on the right side of FIG. 8 to display a navigation screen, such as a map, on transparent OLED 14b1 of display device 14 provided to a windshield. By not displaying display information on transparent OLED 14b2 of display device 14, it is possible to superimpose the navigation screen on the scenery through the windshield.

The two transparent OLEDs may display the display information different from each other, or may display the same or similar display information. When an occupant enjoys exercising in a vehicle during autonomous driving, for example, the transparency of electronic transparency control film 14a may be reduced to display only an instruction video on transparent OLED 14b1 and display two screens of the instruction video and a moving image of an exercising person on transparent OLED 14b2.

Note that the configuration of display device 14 is not limited to the illustrated example. For example, display device 14 may be configured to include only one transparent OLED of the two transparent OLEDs.

The transparency of display device 14 can be changed based on traveling information on traveling of a moving body. The traveling information on traveling of a moving body includes, for example, speed information of a vehicle (vehicle speed), weather information around the current position of a vehicle, current time information, vehicle status information, traffic information, and information indicating a vehicle traveling mode. The transparency of display device 14 can be changed in phases or continuously. Examples of changing the transparency will be described below.

In a case of changing the transparency based on the vehicle speed, display controller 26 uses, for example, table information in which the vehicle speed and the transparency are associated with each other. The table information may be stored in memory device 32B in advance or may be distributed from center server 5. After vehicle speed information is inputted, display controller 26 refers to the table information, configures a first transparency in a case of a first speed range, and configures a second transparency, which is lower than the first transparency, in a case of a second speed range, which is higher than the first speed range, for example. The first transparency is, for example, the visible light transmission of 80%. The second transparency is, for example, the visible light transmission of 30%. The first speed range is, for example, a speed from 0 km/h to 80 km/h. The second speed range is, for example, a speed of 80 km/h or higher. With this configuration, even when the vehicle travels in a town at a speed in the first speed range in the autonomous driving mode and needs to avoid an obstacle, for example, the driver can visually recognize the scenery through the window, and this enables an immediate operation to avoid the obstacle. When the vehicle travels on a bypass road or highway, for example, at a speed in the second speed range in the autonomous driving mode, the driver hardly needs to avoid an obstacle. Thus, blocking the scenery through the window allows the occupant to concentrate on listening to the music, reading, etc. Note that the transparency may be changed in phases according to the vehicle speed, or may be changed continuously according to the vehicle speed. For example, in the first speed range, the transparency may be continuously reduced as the vehicle speed increases from 0 km/h to 80 km/h, for example. Further, in the case where the transparency is changed based on the vehicle speed, display controller 26 may configure the transparency to be higher for a far section where the scenery hardly changes (upper section of a window), and may configure the transparency to be lower for a section where the scenery frequently changes (lower section of a window).

In a case of changing the transparency based on the weather, display controller 26 can change the transparency using, for example, weather information distributed on the Internet, information of a windshield wiper operation state, information of a defogger operation state, and the like. In clear weather, for example, configuring the transparency of entire display device 14 to be around 50% enhances the sense of immersion in the displayed image without the driver and the passenger feeling bright. In cloudy weather, the visibility is deteriorated compared to the case of clear weather, and thus display controller 26 increases the transparency in the area below the center of display device 14, and reduces the transparency in the area above the center of display device 14, for example. With this configuration, a partial area of display device 14 is shaded and the remaining area is not shaded, so that the condition outside the vehicle can be confirmed. This allows the driver to grasp the traffic condition while reducing brightness caused by diffuse reflection of clouds, thus enabling an operation to avoid a pedestrian running out into a road, for example. In addition, the passenger can enjoy the display image or the like. In rainy weather, the visibility is even more deteriorated than the case of cloudy weather, and thus display controller 26 configures the visible light transmission of entire display device 14 to a higher transparency around 80%, for example. This makes it easier to recognize a traffic light, intersection, surrounding vehicle, etc. even in the condition where rain causes poor visibility, thus enabling an operation to avoid a pedestrian running out into a road, for example. In addition, even in a situation where display device 14 provided to the windshield has a high transparency, the passenger can still enjoy the display image, for example, by configuring a low transparency for display device 14 provided to the side window or the like.

In a case of changing the transparency based on the time, for example, the transparency can be changed according to the time by using table information in which time periods, such as early morning, daytime, night, midnight, etc., are associated with a plurality of transparencies different for respective time periods. The table information may be stored in memory device 32B in advance or may be distributed from center server 5. For example, after the time information is inputted, display controller 26 refers to the table information, and configures the transparency of entire display device 14 to be around 50% in the early morning and in the daytime in order to reduce brightness toward the driver or the like. Further, display controller 26 configures the transparency of entire display device 14 to be around 80% at night and midnight in order to ensure the visibility.

In addition, display controller 26 may compare the brightness inside the vehicle with the brightness outside the vehicle, and configure the transparency to be lower only when the inside of the vehicle is brighter than the outside of the vehicle. The comparison between the brightness inside the vehicle and the brightness outside the vehicle is performed by comparing the average luminance level before the white balance adjustment of the outside image capturing device that captures an image of the outside of the vehicle during autonomous driving with the average brightness level before the white balance adjustment of the inside image capturing device that captures an image of the inside of the vehicle.

In a case of changing the transparency based on vehicle status information, for example, a plurality of table information portions are prepared for respective types of the vehicle status information, and each of the table information portions is associated with transparencies with respect to accelerator opening, a brake depression amount, a steering amount of a steering wheel, for example. The table information may be stored in memory device 32B in advance or may be distributed from center server 5.

After information on the accelerator opening is inputted, when the accelerator opening is small, for example, display controller 26 configures the transparency in the area below the center of display device 14 to be around 80%, and configures the transparency in the area above the center of display device 14 to be around 30%. With this configuration, a partial area of display device 14 is shaded when the vehicle cruises on a highway at a constant speed, for example, thereby reducing brightness due to sunlight toward the driver. In addition, the passenger can enjoy an image displayed in the area with lower transparency.

After information on the accelerator opening is inputted, when the accelerator opening is large, for example, display controller 26 configures the transparency of entire display device 14 to be around 80%. With this configuration, display device 14 is not shaded when the vehicle travels on a steep uphill with a series of curves such as a mountain road, for example. This contributes to the driver's safe driving, and allows the passenger to enjoy a display image superimposed on the scenery.

After information on the brake depression amount is inputted, when the number of brake applications in a certain time period is small or when the brake depression amount in a certain time period is small, for example, display controller 26 configures the transparency in the area below the center of display device 14 to be around 80%, and configures the transparency in the area above the center of display device 14 to be around 30%. With this configuration, a partial area of display device 14 is shaded when the vehicle cruises on a highway, for example, thereby reducing brightness due to sunlight toward the driver. In addition, the passenger can enjoy an image displayed in the remaining area.

After information on the brake depression amount is inputted, when the number of brake applications in a certain time period is large or when the brake depression amount in a certain time period is large, for example, display controller 26 configures the transparency of entire display device 14 to be around 80%. With this configuration, display device 14 is not shaded when the vehicle travels in an urban area with heavy traffic, for example. This contributes to the driver's safe driving, and allows the passenger to enjoy a display image superimposed on the scenery.

After information on the steering amount of the steering wheel is inputted, when the number of times the steering wheel is steered in a certain time period is small or when the steering amount of the steering wheel in a certain time period is small, for example, display controller 26 configures the transparency in the area below the center of display device 14 to be around 80%, and configures the transparency in the area above the center of display device 14 to be around 30%. With this configuration, a partial area of display device 14 is shaded when the vehicle cruises on a highway, for example, thereby reducing brightness due to sunlight toward the driver. In addition, the passenger can enjoy an image displayed in the remaining area.

After information on the steering amount of the steering wheel is inputted, when the number of times the steering wheel is steered in a certain time period is large or when the steering amount of the steering wheel in a certain time period is large, for example, display controller 26 configures the transparency of entire display device 14 to be around 80%. With this configuration, display device 14 is not shaded when the vehicle travels in an urban area with heavy traffic, for example. This contributes to the driver's safe driving, and allows the passenger to enjoy a display image superimposed on the scenery.

In a case of changing the transparency based on traffic information, display controller 26 may change the transparency of display device 14 according to the road congestion status. To be more specific, when traffic information distributed while traveling on a highway indicates that the road on which the vehicle is traveling is congested for several minutes, the vehicle speed decreases for a short time. Thus, display controller 26 configures the transparency to be around 80% so that the passenger, for example, can enjoy the scenery through the window. Meanwhile, when the road on which the vehicle is traveling is congested for several tens of minutes or longer, low-speed traveling is forced for a relatively long time. In this case, display controller 26 configures the transparency to be around 30% so that the driver of the vehicle, for example, enjoys a display image rather than the scenery through the window with little change, and changes the transparency from around 30% to around 80% when the traffic congestion is cleared.

In a case of changing the transparency based on information indicating a vehicle traveling mode, display controller 26 changes the transparency depending on, for example, whether the vehicle is in a manual driving mode or an autonomous driving mode (including a driving assist mode, semi-autonomous driving mode, etc.). When the manual driving mode is selected, display controller 26 may change the transparency depending on an eco-driving mode capable of fuel-efficient driving, a sport driving mode capable of active driving, etc. In addition to the above, display controller 26 may configure the transparency of all windows to be reduced when, for example, the vehicle is used as a complete private space by occupant's selection.

Note that display device 14 may be electronic transparency control film 14a combined with a head-up display. In this case, information projected from the head-up unit is projected onto display device 14 provided to a window via a reflective mirror, for example, so that the information can be visually recognized by the driver as a virtual image. At this time, the driving can be finely assisted by changing the transparency of electronic transparency control film 14a depending on the traveling condition. For example, when the vehicle travels on a snow road, display device 14 configures the transparency of a partial area of entire electronic transparency control film 14a on which a virtual image is projected to be lower than the transparency of the other areas, thereby clearly displaying the virtual image superimposed on the snow road.

Note that the head-up display includes a special film similar to a one-way mirror attached to a surface near the passenger, a special film-like material placed inside the glass as an intermediate layer, etc. in order to facilitate visual recognition of a virtual image on the head-up display. In particular, a head-up display using a special film similar to a one-way mirror almost serves as a mirror when the outside of the vehicle is darker than the inside of the vehicle. That is, the interior of the vehicle is reflected in the one-way mirror in a situation where the outside of the vehicle is darker than the inside of the vehicle. Thus, although increasing the luminance of the above transparent OLED worsens the contrast of the transparent OLED, it is better to display an image by partially reducing the transmission of only a display section of the head-up display after adjusting the image by increasing the black level (black luminance), or making the image without black. Besides the special film similar to a one-way mirror described above, a holographic optical element (HOE) that diffracts only a certain wavelength can also be exemplified, and this case eliminates the need for the above-described image adjustment.

In addition to the above, display controller 26 may change the transparency by using, for example, information distributed in V2X communication. The V2X communication enables not only vehicle-to-vehicle communication but also communication between a vehicle and a person having a communication terminal, communication between a vehicle and a roadside unit, etc. The V2X communication provides, for example, information indicating a traffic light status, traffic regulation information, traffic obstacle information (information on icy road surfaces, flooded roads, falling objects on roads, etc.), and position information of a moving object present around the vehicle. For example, when a vehicle equipped with display device 14 turns right and a moving body, such as a bicycle or a motorcycle, approaches the vehicle from behind, using the above information makes it possible to display the moving body on display device 14 in real time. It is also possible to make the driver visually recognize the moving body by display controller 26 switching the transparency of electronic transparency control film 14a provided to a side window, for example, from low to high when the distance between the moving body and the vehicle is shorter than a configured distance. When it is determined that the moving body cannot avoid colliding with vehicle, display controller 26 may display a warning message on display device 14. To be more specific, by using captured image information acquired from the outside image capturing device, for example, display controller 26 displays an image of the moving body approaching the vehicle on display device 14 in real time, and also estimates the approaching speed of the moving body toward the vehicle based on the position of the moving body present around the vehicle, the movement amount of the moving body per unit time, and the like. When it is determined from the estimated speed that the moving body cannot avoid colliding with vehicle, display controller 26 displays a warning message on display device 14. In addition, when receiving flood information, display controller 26 can determine the flooded area, the amount of flooding, and detour routes to bypass the flooded area, for example, in cooperation with a navigation system, and display the determined information on display device 14.

Next, an exemplary transparency change and exemplary displays of display information on the screen of display device 14 will be described with reference to FIG. 9 and the like.

FIG. 9 illustrates a situation where the transparency is changed in accordance with vehicle speed. As illustrated in FIG. 9, when the vehicle is stopped or the vehicle speed is equal to or slower than a certain speed, the transparency is configured to be high so that the occupant can enjoy the scenery through window 2. When the vehicle starts traveling or the vehicle speed exceeds the certain speed, the transparency of display device 14 is reduced. Note that the transparency may be changed in phases or continuously according to the vehicle speed, as described above.

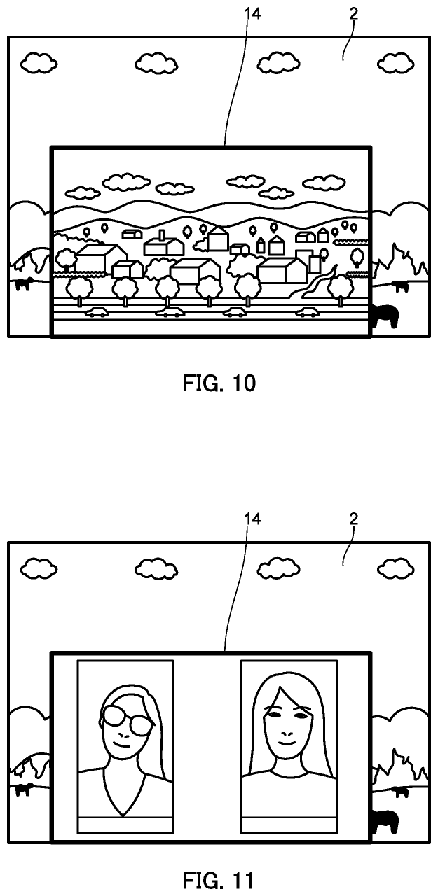

FIG. 10 illustrates a situation where a VR image, for example, is displayed in accordance with change in the transparency. As illustrated in FIG. 10, the occupant can enjoy a VR image on display device 14 by launching a predetermined application in a situation where the scenery through window 2 is invisible due to reduction of the transparency according to the vehicle speed. Note that, to generate the VR image, a dynamic map distributed by center server 5, for example, can be used. This makes it possible to display the real world corresponding to the current position of the vehicle as virtual reality.

FIG. 11 illustrates a situation where AR try-on and AR make-up, for example, are performed in accordance with change in the transparency. A technique used for the AR try-on is to combine an image of clothes with a captured image of a user captured using a smartphone, for example (see Japanese Patent Application Laid-Open No. 2013-101529, for example). For the AR make-up, the technique disclosed in Non Patent Literature 2 can be used, for example (Non Patent Literature 2: https://bae.dentsutec.co.jp/articles/makeup/). As illustrated in FIG. 11, the occupant can enjoy the AR try-on and AR make-up, for example, on display device 14 by launching a predetermined application in a situation where the scenery through window 2 is invisible due to reduction of the transparency according to the vehicle speed. In particular, once level 4 autonomous driving is implemented, demand for the AR try-on and AR make-up in a moving vehicle possibly increases dramatically. Display device 14 according to the present embodiment is useful for meeting the needs.

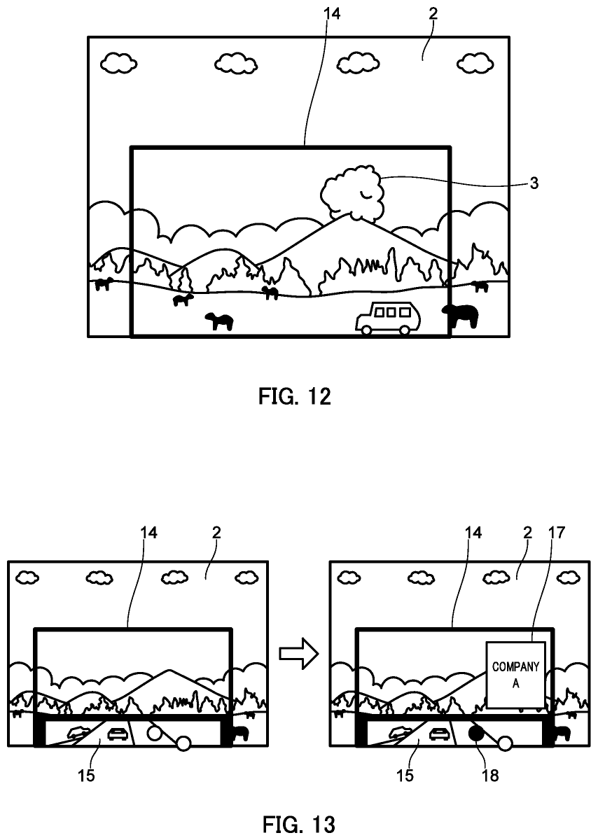

FIG. 12 illustrates a situation where the transparency of the display device is increased and an AR image, for example, is superimposed on the scenery through the window. As illustrated in FIG. 12, AR image 3 can be displayed on the scenery (e.g., mountaintop) seen by a driver by utilizing the display position of the display information determined by display position determiner 22 when the vehicle travels slowly or is stopped, for example. At this time, the transparency of display device 14 is configured to be high.

FIG. 13 illustrates a situation where information of a hot spot, for example, is displayed. As illustrated in FIG. 13, bird's-eye view 15 can be superimposed on display device 14. In addition, when information such as hot spot 18 displayed on bird's-eye view 15 is selected, details of the information may be displayed on the screen of display device 14. The information is, for example, information directly connected to the occupant's interest, more specifically, an advertisement of a certain company (e.g., company A 17), and event information.

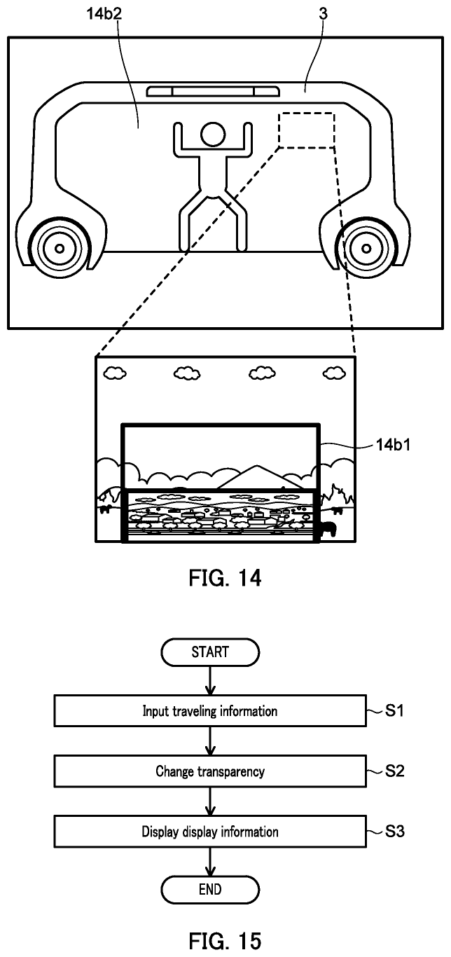

FIG. 14 illustrates a situation where different images are respectively displayed inside and outside the vehicle. As illustrated in the lower section of FIG. 14, when a person in the vehicle in the autonomous driving mode plays a game in which a character moves in conjunction with the person's movement, for example, the game screen can be displayed on transparent OLED 14b1 and an enlarged image of the person in the vehicle can be displayed on transparent OLED 14b2 while the transparency of electronic transparency control film 14a is reduced.

In addition to the above, a local dimming function for configuring the transparency of a partial area of display device 14 to be lower than the transparency of the surrounding area can be used to display a bird's-eye view of the entire traveling road on the area with low transparency, for example, and to display the screen illustrated in FIG. 10, FIG. 11, or FIG. 12 on the area with high transparency.

Display device 14 may have a configuration in which light-shielding films (electronic transparency control films 14a) have a transparent OLED in between, for example. In a case of such a configuration, the light-shielding films have high transparency when they are turned off in display device 14, and thus the scenery can be seen from the inside of the vehicle through the two transparent displays. Meanwhile, the light-shielding films have low transparency when they are turned on, and thus different images can be respectively displayed inside and outside the vehicle. In this case, it is possible to display inside the vehicle, for example, a scene of competition using play equipment with a riding chair and calories burned through exercise, and outside the vehicle, an AR image of a character decorated by an occupant moving in accordance with the movement of the play equipment. This enhances enjoyment inside the vehicle and enables promotion to the outside of the vehicle, thereby increasing the entertainment value for both the occupant inside the vehicle and the audience outside the vehicle.

Display device 14, for example, may configure the transparency when the vehicle enters a certain place to be different from the transparency before the vehicle enters the certain place. For example, when detecting that the vehicle enters a tunnel using map information, display controller 26 may configure the transparency of display device 14 provided to the windshield to be high in order to assist driver's safe driving while maintaining the transparency of display device 14 provided to a side window at a low level so that the occupant enjoys an image. In addition, when detecting that the vehicle comes out from the tunnel using the map information, display controller 26 may increase the transparency of display device 14 provided to the windshield so as to enable a driver's easier operation to avoid a pedestrian running out into a road, for example, while not changing the transparency of display device 14 provided to the side window.

The image displayed on display device 14 may be changed in accordance with the above-described traveling information related to traveling of a vehicle. For example, when detecting that the vehicle has arrived in front of a certain building using map information, display controller 26 may acquire a character configured for the building via center server 5 and display the character on display device 14.

When the vehicle enters a certain area, for example, display device 14 may display object information of an advertisement, character, etc., and change the object information in accordance with the time of day the moving body is moving or an attribute of a user, for example. With this configuration, for example, display of inappropriate image for children can be restricted and a character associated with a building can be visually recognized via display device 14 even when the whole city is dark as at night.

Note that display device 14 according to the present embodiment includes at least a transmissive display provided to a window of a moving body, and need not include a display information display for displaying display information so as to be superimposed on the transmissive display. For example, increasing the transparency allows an occupant of a vehicle to enjoy the scenery through the window, and reducing the transparency creates an environment where the occupant can concentrate on reading or listening to music. Increasing the transparency also makes it possible to show people outside the vehicle the occupant enjoying exercise or playing a game inside the vehicle. As described above, display device 14 according to the present embodiment enhances the entertainment on a window of a moving body by changing the transparency in accordance with the traveling status, for example. Note that, when display device 14 further includes the display information display for displaying display information so as to be superimposed on the transmissive display, it is possible to change the display information on the display information display as well as to change the transparency based on the traveling information, for example. This enhances the entertainment on a window of a moving body even more.

A person wearing, for example, a head mounted display that allows people around the person to appear through the glasses can enjoy an image, video, etc. individually, but cannot share the enjoyment with the people around the person appearing through the glasses since the image, video, etc. cannot be shared with the people and face-to-face communication with the people is not allowed. Display device 14 according to the present embodiment makes it possible to share the image, video, etc. among people outside and inside the vehicle by changing the transparency, and thus display device 14 possibly functions as a new communication tool that enables face-to-face communication among people outside and inside the vehicle.

FIG. 15 is a flowchart for describing a display method of the display device. The display method of display device 14 according to the present embodiment includes: inputting traveling information on traveling of a moving body (S1); changing transparency of a transmissive display provided to the moving body based on the inputted traveling information (S2); and displaying, based on the inputted traveling information, display information so as to be superimposed on the transmissive display, the transparency of which is changed (S3).

As described above, display device 14 according to the present embodiment includes a transmissive display that is provided to a window of a moving body, and changes transparency of the transmissive display based on traveling information on traveling of the moving body. With this configuration, the transparency is changed in accordance with a traveling status, for example, thereby enhancing the entertainment on the window of the moving body.

Display device 14 according to the present embodiment may be configured to change the transparency based on the traveling information indicating a speed of the moving body.

Display device 14 according to the present embodiment may be configured to reduce the transparency as the speed increases and may be configured to increase the transparency as the speed reduces.

Display device 14 according to the present embodiment may be configured to change the transparency in phases in accordance with change in the speed, and may be configured to change the transparency continuously in accordance with change in the speed.

Display device 14 according to the present embodiment may be configured to change the transparency based on the traveling information indicating a position of the moving body.

Display device 14 according to the present embodiment may be configured to configure the transparency when the moving body enters a predetermined location to be different from the transparency before the moving body enters the predetermined location.

Display device 14 according to the present embodiment may be configured to change the transparency based on, for example, the traveling information indicating weather around the moving body, the traveling information indicating time of day the moving body is moving, the traveling information broadcasting to a user, and/or the traveling information indicating an attribute of a user.

The traveling information broadcasting to a user includes, for example, Earthquake Early Warning, information indicating the magnitude level of an earthquake, and a storm warning. For example, display device 14 maintains low transparency when the magnitude level of the earthquake is relatively low, and changes the transparency from low to high when the magnitude level of the earthquake is relatively high, so that a driver and the like can visually recognize the situation around the vehicle.

The traveling information indicating an attribute of a user is information on an occupant of the traveling vehicle, and includes a user ID, gender, birthday, occupation, and place of residence, for example. When information of a cartoon character is embedded in a certain point on a map and there is a child on the vehicle, for example, display controller 26 recognizes a face of an occupant of the vehicle using captured image information and determines whether it is a child. When it is a child, display controller 26 can display the character on display device 14 as the vehicle approaches the point where the character is present using map information.

The vehicle possibly passes through the place of the character in a short time depending on the vehicle speed. Thus, when the vehicle speed is high, the direction of the place where the character appears, the distance to the place, etc. may be displayed on the screen of display device 14 in advance as text information.

Display device 14 according to the present embodiment may be configured to change the transparency of a partial area of an entirety of the transmissive display based on the traveling information.

Further, display device 14 according to the present embodiment may be configured to further include a display information display for displaying display information so as to be superimposed on the transmissive display, and may be configured to change the display information on the display information display as well as the transparency based on the traveling information.

The display information display of display device 14 according to the present embodiment may be configured to change, as well as the transparency, an AR image to an MR image, an MR image to an AR image, an MR image to a VR image, a VR image to an MR image, a VR image to an AR image, or an AR image to a VR image.

Note that display controller 26 may be incorporated in ECU 32, or may be incorporated in display device 14. Display controller 26 may configure the transparency when the moving body is stopped to be higher than the transparency when the moving body is traveling. Display controller 26 may also be configured to change the transparency based on the traveling information indicating an attribute of a pedestrian.

Note that the configuration of display device 14 is not limited to the above examples, and display device 14 may have a configuration where a light-dimming film whose light transmission changes electronically, for example, is laminated to a transparent liquid crystal display, transparent organic EL display, transparent micro LED, or transparent screen film that forms a projector image. The film laminated to the glass is placed within, for example, 90% of the outer shape of the glass visible from the inside of the vehicle. This makes the film have an additional function of preventing the glass from shattering when a person is trapped inside the vehicle and breaks the window to escape.

The display information display may be configured to change the transparency so that scenery through the transmissive display is easy to be seen, or changes the transparency so that scenery through the transmissive display is difficult to be seen.

While various embodiments have been described with reference to the drawings herein above, the present disclosure is obviously not limited to these examples. Obviously, a person skilled in the art would conceive variations and modification examples within the scope described in the claims, and it is to be appreciated that these variations and modifications naturally fall within the technical scope of the present disclosure. Each constituent element of the above-mentioned embodiments may be combined optionally without departing from the spirit of the disclosure.

Although specific examples of the present embodiment have been described in detail, those are merely examples and it is not intended to limit the scope of the claims. The techniques described in the claims include variations and modifications of the specific examples described above.

The disclosure of Japanese Patent Application No. 2020-050757, filed on Mar. 23, 2020, including the specification, drawings and abstract, is incorporated herein by reference in its entirety.

While various embodiments have been described herein above, it is to be appreciated that various changes in form and detail may be made without departing from the spirit and scope of the inventions(s) presently or hereafter claimed.

This application is entitled and claims the benefit of Japanese Patent Application No. 2020-050757, filed on Mar. 23, 2020, the disclosure of which including the specification, drawings and abstract is incorporated herein by reference in its entirety.

### INDUSTRIAL APPLICABILITY

An exemplary embodiment of the present disclosure is suitable for a display device and a vehicle.

### REFERENCE SIGNS LIST

1 Display system
3 Moving body
5 Center server
14 Display device
14a Electronic transparency control film
22 Display position determiner
26 Display controller
30 On-board device
32A Auxiliary storage device
32B Memory device
32D Interface device
32E Bus line
33 GPS module
34 ACC switch
35 Sensor
36 Image capturing device
51 Communication device
52 Information processing apparatus
321 Vehicle information transceiver
323 Captured image information manager
520 Storage
5201 Communication processor
5205 Information display object extractor
5212 Vehicle identifier
5213 Command transmitter
5214 Map matcher
5215 Probe information generator
d1 Display information
d2 Display information
d3 Display information

1. A display device, comprising:
a transmissive display that is provided to a moving body; and
a display controller that changes transparency of the transmissive display based on traveling information on traveling of the moving body.

2. The display device according to claim 1, wherein the display device changes the transparency based on the traveling information indicating a speed of the moving body.

3. The display device according to claim 2, wherein the display device reduces the transparency as the speed increases.

4. The display device according to claim 2, wherein the display device increases the transparency as the speed reduces.

5. The display device according to claim 3, wherein the display device changes the transparency in phases in accordance with change in the speed.

6. The display device according to claim 3, wherein the display device changes the transparency continuously in accordance with change in the speed.

7. The display device according to claim 2, wherein the display device configures the transparency when the moving body is stopped to be higher than the transparency when the moving body is traveling.

8. The display device according to claim 1, wherein the display device changes the transparency based on the traveling information indicating a position of the moving body.

9. The display device according to claim 2, wherein the display device configures the transparency when the moving body enters a predetermined location to be different from the transparency before the moving body enters the predetermined location.

10. The display device according to claim 1, wherein the display device changes the transparency based on the traveling information indicating weather around the moving body.

11. The display device according to claim 1, wherein the display device changes the transparency based on the traveling information indicating time of day the moving body is moving.

12. The display device according to claim 1, wherein the display device changes the transparency based on the traveling information broadcasting to a user.

13. The display device according to claim 1, wherein the display device changes the transparency based on the traveling information indicating an attribute of a user.

14. The display device according to claim 1, wherein the display device changes the transparency based on the traveling information indicating an attribute of a pedestrian.

15. The display device according to claim 1, wherein the display device changes the transparency of a partial area of an entirety of the transmissive display based on the traveling information.

16. The display device according to claim 1, wherein the display device further comprises a display information display for displaying display information so as to be superimposed on the transmissive display, and changes the display information on the display information display as well as the transparency based on the traveling information.

17. The display device according to claim 16, wherein the display information display changes, as well as the transparency, an AR image to an MR image, an MR image to an AR image, an MR image to a VR image, a VR image to an MR image, a VR image to an AR image, or an AR image to a VR image.

18. The display device according to claim 16, wherein the display information display changes the transparency so that scenery through the transmissive display is easy to be seen, or changes the transparency so that scenery through the transmissive display is difficult to be seen.

19. A vehicle comprising the display device according to claim 1.

20. A display method, comprising:
inputting traveling information on traveling of a moving body;
changing transparency of a transmissive display provided to the moving body based on the inputted traveling information; and
displaying, based on the inputted traveling information, display information so as to be superimposed on the transmissive display, the transparency of which is changed.
